(19) United States
(12) Patent Application Publication
(10) Pub. No.: US 2012/0249045 A1
(43) Pub. Date: Oct. 4, 2012

(54) MEDIUM VOLTAGE INVERTER SYSTEM

(75) Inventor: Kyungsue KIM, Bucheon-si (KR)

(73) Assignee: LSIS CO., LTD., Anyang-si (KR)

(21) Appl. No.: 13/410,193

(22) Filed: Mar. 1, 2012

(30) Foreign Application Priority Data
Apr. 1, 2011 (KR) 10-2011-0030204

(51) Int. Cl. H02P 27/06

(52) U.S. Cl. 318/768

(57) ABSTRACT

A medium voltage inverter system is disclosed, the system including a coupled reactor magnetically connecting first and second reactors each connected to an output of first and second medium voltage inverters for driving a motor.

### CROSS REFERENCE TO RELATED APPLICATIONS

Pursuant to 35 U.S.C.§119 (a), this application claims the benefit of earlier filing date and right of priority to Korean Patent Application No. 10-2011-0030204, filed on Apr. 1, 2011, the contents of which is hereby incorporated by reference in their entirety.

### BACKGROUND OF THE DISCLOSURE

1. Field

The present disclosure relates to a medium voltage inverter system, and more particularly to a medium voltage inverter system configured to be used for a motor by connecting two medium voltage inverters in parallel.

2. Background

Generally, two or more inverters are connected in parallel to increase capacity of the inverter in a medium voltage inverter system using 3,300-11,000 high voltages.

FIG. 1 is a schematic diagram illustrating a medium voltage inverter system according to prior art.

Referring to FIG. 1, a circulating current is generated by an output voltage difference (size, phase, frequency, etc) of two inverters (A=110, B=120) in a case the two inverters (110, 120) are connected in parallel for driving a motor (130). The circulating current disables to maximally use a rated capacity of the parallel-connected inverters (110, 120, and if the circulating current grows larger, there is a high probability of occurrence of an accident.

The circulating current is generated by a voltage difference between the two inverters (110, 120). Even if synchronization control of two inverters (110, 120) is accurately carried out to make phases and frequencies of output voltage equal, an inverter DC link voltage difference and PWM (Pulse Width Modulation) switch timing cannot be precisely same. As a result, a circulating current is always generated by the PWM pulsation to cause a loss to an inverter output.

Furthermore, if the synchronization control is out of order, a situation comes up in which two voltage sources face each other to make an over-current flow, causing a burden to the system. In order to limit the flow of over-current, reactors (140, 150) are inevitably used as essential components in a parallel operation.

These reactors (140, 150) serve as impedance components to reduce the size of the circulating current, in a case a voltage difference is generated between two inverters (110, 120). Thus, inductances (L_{A}, L_{B}) of the reactors (140, 150) are determined as the values at which the system sustains the circulating current when the difference between the two inverters (110, 120) is maximized for an instant time.

Each of the invertors (110, 120) in the parallel-connected system with the circulating current-limiting reactors applies an output voltage to a circuit in which the reactors (140, 150) and the motor (130) are connected in series. Thus, as the designed inductances of the reactors (140, 150) increase, voltage drop (V_{LA}, V_{LB}) to the motor (130) generated by the reactors also increase, such that it is inevitable to increase the output voltage of the inverters (110, 120) as much as reduction of the voltage drop.

However, the voltage drop (V_{LA}, V_{LB}) generated by the reactors (140, 150) are problematic due to being a cause of deteriorating efficiency of the system. Therefore, a problem is generated in which the high voltage inverter system is not applied with a parallel operation because of the voltage drop.

### SUMMARY

The present disclosure has been proposed to solve the foregoing problem, and an object of certain embodiments of the present disclosure is to provide a medium voltage inverter system configured to minimize a voltage drop in a parallel-connected inverter to enable an efficient parallel operation of the medium voltage inverter.

In one general aspect of the present disclosure, there is provided a medium voltage inverter system for driving a motor, the medium voltage inverter system comprising: first and second medium inverters that are parallel connected; and a coupled reactor magnetically connecting first and second reactors each connected to an output of the first and second medium voltage inverters.

Preferably, the each self inductance of the first and second reactors and a mutual inductance of the coupled reactor are substantially same.

Preferably, a circulating current by the first and second medium inverters is restricted by controlling the self inductance of each of the first and second reactors and the mutual inductance of the coupled reactor.

In another general aspect of the present disclosure, there is provided a medium voltage inverter system applied with a three-phase voltage for driving a motor, the medium voltage inverter system comprising: first and second medium voltage inverters, each output being a three phase, wherein first, second and third reactors are connected to the three-phase output of the first medium voltage inverter, and fourth, fifth and sixth reactors are connected to the three phase output of the second medium voltage inverter; a first coupled reactor magnetically connecting the first and fourth reactors; a second coupled reactor magnetically connecting the second and fifth reactors; and a third coupled reactor magnetically connecting the third and sixth reactors.

Preferably, the fourth, fifth and sixth reactors sequentially correspond in phases thereof to those of the first, second and third reactors.

Preferably, the first and second medium voltage inverters are connected in parallel.

Preferably, the each self inductance of the first and fourth reactors and the mutual inductance of the first coupled reactor are substantially same.

Preferably, the each self inductance of the second and fifth reactors and the mutual inductance of the second coupled reactor are substantially same.

Preferably, the each self inductance of the third and sixth reactors and the mutual inductance of the third coupled reactor are substantially same.

The medium voltage inverter system according to the present disclosure is advantageous in that a voltage reduction generated by a reactor is offset to restrict only a circulating current in a case a normal output current flows, by using a coupled reactor method through magnetic connection of reactors used for restricting the circulating current for each phase in a case medium voltage inverters are driven in parallel.

Various aspects and embodiments of the invention are described in further detail below.

The Summary is neither intended nor should it be construed as being representative of the full extent and scope of the present invention, which these and additional aspects will become more readily apparent from the detailed description, particularly when taken together with the appended drawings. As mentioned above, the Summary is not an extensive overview and is not intended to identify key or critical elements of the apparatuses, methods, systems, processes, and the like, or to delineate the scope of such elements. Therefore, the Summary provides a conceptual introduction in a simplified form as a prelude to the more-detailed description that follows.

### BRIEF DESCRIPTION OF THE DRAWINGS

The accompanying drawings, which are included to provide further understanding of the disclosure and are incorporated in and constitute a part of this application, illustrate embodiment(s) of the disclosure and together with the description serve to explain the principle of the disclosure. In the drawings:

FIG. 1 is a schematic block diagram illustrating a medium voltage inverter system according to prior art;

FIG. 2 is a schematic block diagram illustrating a medium voltage inverter system according to an exemplary embodiment of the present disclosure;

FIG. 3 is a circuit diagram of FIG. 2 according to an exemplary embodiment of the present disclosure; and

FIG. 4 is a schematic view illustrating a three phase circuit diagram of FIG. 2.

### DETAILED DESCRIPTION

The disclosed embodiments and advantages thereof are best understood by referring to FIGS. 1-4 of the drawings, like numerals being used for like and corresponding parts of the various drawings. Other features and advantages of the disclosed embodiments will be or will become apparent to one of ordinary skill in the art upon examination of the following figures and detailed description. It is intended that all such additional features and advantages be included within the scope of the disclosed embodiments, and protected by the accompanying drawings. Further, the illustrated figures are only exemplary and not intended to assert or imply any limitation with regard to the environment, architecture, or process in which different embodiments may be implemented. Accordingly, the described aspect is intended to embrace all such alterations, modifications, and variations that fall within the scope and novel idea of the present invention.

It will be understood that the terms “includes”, “including”, “have” and/or “having” when used in this specification, specify the presence of stated features, regions, integers, steps, operations, elements, and/or components, but do not preclude the presence or addition of one or more other features, regions, integers, steps, operations, elements, components, and/or groups thereof. That is, the terms “including”, “includes”, “having”, “has”, “with”, or variants thereof are used in the detailed description and/or the claims to denote non-exhaustive inclusion in a manner similar to the term “comprising”.

Furthermore, “exemplary” is merely meant to mean an example, rather than the best. It is also to be appreciated that features, layers and/or elements depicted herein are illustrated with particular dimensions and/or orientations relative to one another for purposes of simplicity and ease of understanding, and that the actual dimensions and/or orientations may differ substantially from that illustrated. That is, in the drawings, the size and relative sizes of layers, regions and/or other elements may be exaggerated or reduced for clarity. Like numbers refer to like elements throughout and explanations that duplicate one another will be omitted. Now, the present invention will be described in detail with reference to the accompanying drawings.

Words such as “thereafter,” “then,” “next,” etc. are not intended to limit the order of the processes; these words are simply used to guide the reader through the description of the methods.

It will be understood that when an element is referred to as being “connected” or “coupled” to another element, it can be directly connected or coupled to the other elements or intervening elements may be present. In contrast, when an element is referred to as being “directly connected” or “directly coupled” to another element, there are no intervening elements present. As used herein, the term “and/or” includes any and all combinations of one or more of the associated listed items and may be abbreviated as “/”.

The terminology used herein is for the purpose of describing particular embodiments only and is not intended to be limiting of the general inventive concept. As used herein, the singular forms “a”, “an” and “the” are intended to include the plural forms as well, unless the context clearly indicates otherwise.

It will be understood that, although the terms first, second, etc. may be used herein to describe various elements, these elements should not be limited by these terms. These terms are only used to distinguish one element from another. For example, a first region/layer could be termed a second region/layer, and, similarly, a second region/layer could be termed a first region/layer without departing from the teachings of the disclosure.

Now, a medium voltage inverter system according to an exemplary embodiment of the present disclosure will be described in detail with reference to the accompanying drawings.

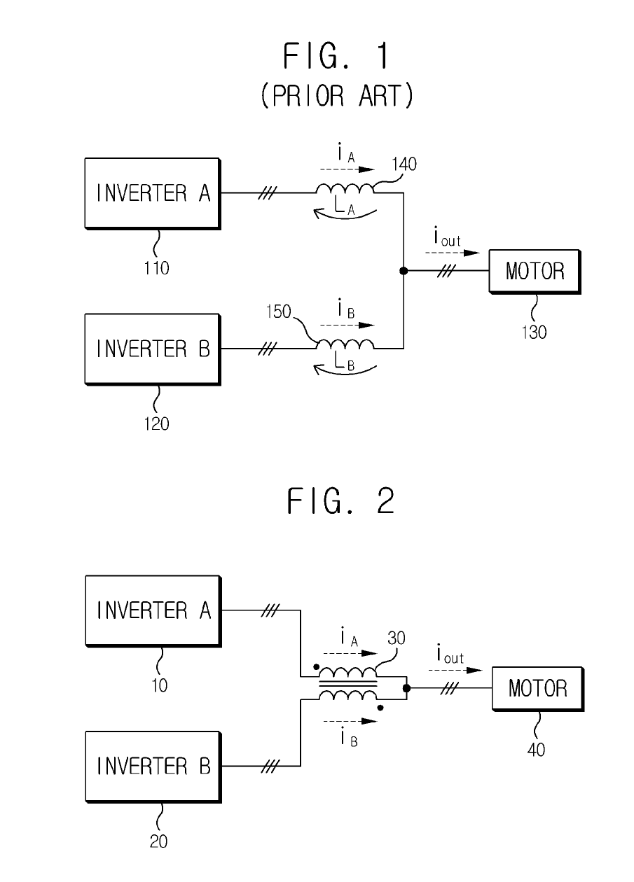

FIG. 2 is a schematic block diagram illustrating a medium voltage inverter system according to an exemplary embodiment of the present disclosure.

Referring to FIG. 2, a medium voltage inverter system according to the present disclosure includes two inverters (10, 20) connected in parallel for driving a motor (40), and a coupled reactor (30) magnetically connecting a reactor installed at each output of the inverters (10, 20).

The coupled reactor (30) according to the present disclosure is configured by magnetically connecting a copper wire of reactors arranged at each output of the inverters (10, 20) and winding the copper wire on an iron core, the concept of which is obvious to the skilled in the art.

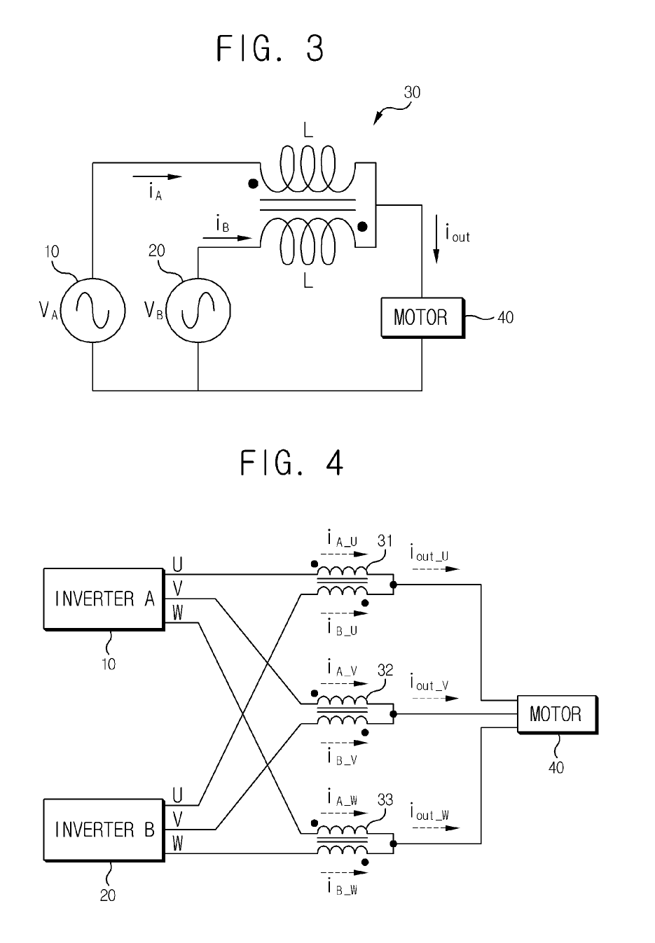

FIG. 3 is a circuit diagram of FIG. 2 according to an exemplary embodiment of the present disclosure, where each self inductance of the reactors is defined as L, and each mutual inductance is defined as M.

A voltage applied to the coupled reactor (30) in FIG. 3 may be expressed by the following equation 1.

$${V}_{A} - {V}_{out} = L \frac{{di}_{A}}{d t} - M \frac{{di}_{B}}{d t} \\ {V}_{B} - {V}_{out} = L \frac{{di}_{B}}{d t} - M \frac{{di}_{A}}{d t} \qquad [ Equation 1 ]$$

where, V_{A} is a voltage applied to the inverter A (10), V_{B} is a voltage applied to the inverter B (20), Vₒᵤₜ is a voltage applied to the motor (40), i_{A} is a current flowing from the inverter A (10), i_{B} is a current flowing from the inverter B (20) and iₒᵤₜ is a current flowing from the coupled reactor (30) to the motor (40).

The current and voltages in the Equation 1 may be basically divided into a fundamental wave component ( V̅) and a micro-component (V %) by PWM (Pulse Width Modulation). In order to reflect the foregoing, the Equation 1 may be expressed as below:

$${\overline{V}}_{A} + {V}_{A}^{\%} - ( {\overline{V}}_{out} + {V}_{out}^{\%} ) = L ( \frac{d {\overline{i}}_{A}}{d t} + \frac{{di}_{A}^{\%}}{d t} ) - M ( \frac{d {\overline{i}}_{B}}{d t} + \frac{{di}_{B}^{\%}}{d t} ) \\ {\overline{V}}_{B} + {V}_{B}^{\%} - ( {\overline{V}}_{out} + {V}_{out}^{\%} ) = L ( \frac{d {\overline{i}}_{B}}{d t} + \frac{{di}_{B}^{\%}}{d t} ) - M ( \frac{d {\overline{i}}_{A}}{d t} + \frac{{di}_{A}^{\%}}{d t} ) \qquad [ Equation 2 ]$$

where, a fundamental wave voltage of each inverter being equal, V_{A}=V_{B}, and a current to a load is a sum of currents flowing in the two inverters (10, 20), such that

$${\overline{i}}_{A} = {\overline{i}}_{B} = \frac{1}{2} {\overline{i}}_{out} ,$$

and a pulsating component of inverter voltage is ½ of pulsating component of the load voltage, and

$$\frac{{V}_{A}^{\%} + {V}_{B}^{\%}}{2} = {V}_{out}^{\%} .$$

Therefore, a voltage drop in the fundamental wave generated by using the coupled reactor (30) may be expressed by the following equation:

$${\overline{V}}_{A -} {\overline{V}}_{B} = \frac{L - M}{2} \frac{d {\overline{i}}_{out}}{d t} \qquad [ Equation 3 ]$$

In view of the foregoing Equation 3, if the self inductance L and the mutual inductance M are same, it should be noted that the fundamental wave voltage drop by the coupled reactor (30) may be disregarded.

Furthermore, a voltage drop by a circulating current of PWM pulsation may be obtained by the following equation through simplification of the above equation.

$${V}_{A}^{\%} - {V}_{B}^{\%} = ( L + M ) \frac{d}{d t} ( {i}_{A}^{\%} - {i}_{B}^{\%} ) \qquad [ Equation 4 ]$$

In view of the above equation, it should be noted that a circulating current by PWM pulsation may be restricted by the self inductance L and the mutual inductance M.

The ‘III’ in FIG. 2 shows that a power applied to the inverter is a three phase, where each phase is illustrated by FIG. 4.

FIG. 4 is a schematic view illustrating a three phase circuit diagram of FIG. 2, where FIG. 4 explains that a circuit of three phases is formed in a case the coupled reactor (30) is applied.

As illustrated in the drawing, the reactor is coupled to each phase, and in case of three phased inverter, it should be apparent that three coupled reactors (31, 32 and 33) may be included.

As noted from the foregoing, the medium voltage inverter system according to the present disclosure has an industrial applicability in that a voltage reduction component generated by a reactor is offset to restrict only a circulating current in a case a normal output current flows, by using a coupled reactor method through magnetic connection of reactors used for restricting the circulating current for each phase in a case medium voltage inverters are driven in parallel.

Although the present disclosure has been described with reference to a number of illustrative embodiments thereof, it should be understood that numerous other modifications and embodiments can be devised by those skilled in the art that will fall within the spirit and scope of the principles of this disclosure.

More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A medium voltage inverter system for driving a motor, the system comprising: first and second medium inverters that are parallel connected; and a coupled reactor magnetically connecting first and second reactors each connected to an output of the first and second medium voltage inverters.

2. The system of claim 1, wherein the each self inductance of the first and second reactors and a mutual inductance of the coupled reactor are substantially same.

3. The system of claim 1, wherein a circulating current by the first and second medium inverters is restricted by controlling the self inductance of each of the first and second reactors and the mutual inductance of the coupled reactor.

4. A medium voltage inverter system applied with a three-phase voltage for driving a motor, the system comprising:
first and second medium voltage inverters, each output being a three phase, wherein first, second and third reactors are connected to the three-phase output of the first medium voltage inverter, and fourth, fifth and sixth reactors are connected to the three phase output of the second medium voltage inverter; a first coupled reactor magnetically connecting the first and fourth reactors; a second coupled reactor magnetically connecting the second and fifth reactors; and a third coupled reactor magnetically connecting the third and sixth reactors.

5. The system of claim 4, wherein the fourth, fifth and sixth reactors sequentially correspond in phases thereof to those of the first, second and third reactors.

6. The system of claim 4, wherein the first and second medium voltage inverters are connected in parallel.

7. The system of claim 4, wherein the each self inductance of the first and fourth reactors and the mutual inductance of the first coupled reactor are substantially same.

8. The system of claim 4, wherein the each self inductance of the second and fifth reactors and the mutual inductance of the second coupled reactor are substantially same.

9. The system of claim 4, wherein the each self inductance of the third and sixth reactors and the mutual inductance of the third coupled reactor are substantially same.
